(19) United States
(12) Patent Application Publication
(10) Pub. No.: US 2009/0046174 A1
(43) Pub. Date: Feb. 19, 2009

(54) SOLID STATE IMAGING DEVICE AND DRIVING METHOD THEREFOR

(76) Inventors: Koujirou Yoneda, Osaka (JP); Ryohei Miyagawa, Kyoto (JP)

Correspondence Address: MCDERMOTT WILL & EMERY LLP, 600 13TH STREET, NW, WASHINGTON, DC, 20005-3096, US

(21) Appl. No.: 12/158,259

(22) PCT Filed: Dec. 19, 2006
(86) PCT No.: PCT/JP2006/325280

§ 371 Date: Jun. 19, 2008

(30) Foreign Application Priority Data
Dec. 19, 2005 (JP) 2005-365088

(51) Int. Cl. H04N 5/76; H04N 5/335

(52) U.S. Cl. 348/231.99; 348/294; 348/E05.091

(57) ABSTRACT

A solid state imaging device includes an imaging circuit 50 and a signal processing circuit 51. The imaging circuit 50 includes a plurality of pixels arranged in a matrix and outputs signals of the pixels line by line as an imaging signal containing a discontinuous portion. The signal processing circuit 51 has a memory 54 which temporarily stores the imaging signal and a memory controller 53 which writes and reads the imaging signal to and from the memory 54. The signal processing circuit converts the imaging signal containing the discontinuous portion into a continuous image signal.

### TECHNICAL FIELD

The present invention relates to a solid state imaging device and a driving method therefor. In particular, it relates to a solid state imaging device which performs electronic shuttering operation and a driving method therefor.

### BACKGROUND ART

FIG. 6 shows an example of a conventional solid state imaging device including MOS transistors. (cf. Patent Literature 1). As shown in FIG. 6, the conventional solid state imaging device includes an imaging region 110 in which a plurality of amplifying unit pixels are arranged in a two-dimensional array.

Each of the amplifying unit pixels includes elements formed on a semiconductor substrate, such as a photodiode (PD) 111, a floating diffusion (FD) 117 connected to the PD 111 through a readout transistor 112 to read and store a charge of the PD 111, a reset transistor 113 which resets the state of the FD 117 and a sensing transistor 114 connected to the FD 117 to control a pixel signal.

Sources of the sensing transistors 114 are connected to vertical signal lines 115 provided in one-to-one correspondence with the columns. Each of the vertical signal lines 115 is connected to a line memory 123 and a source of a load transistor 118.

A vertical shift register 141 which is operated by a drive timing pulse supplied from a timing generator circuit 140 selects the amplifying unit pixels by lines. Signals of the amplifying unit pixels on the selected line are stored in the line memories 123 when the load transistors 118 are on. Then, a horizontal shift register 142 is driven by a drive timing pulse supplied from the timing generator circuit 140 such that the pixel signals stored in the line memories 123 are sequentially output from an output amplifier 127 as an imaging signal through a horizontal signal line 126.

FIG. 7 shows the timing of the operation of the conventional solid state imaging device in a horizontal drive period not overlapping with a vertical blanking period. The horizontal drive period consists of a horizontal blanking period (HBLANK) and a horizontal effective period. In the horizontal blanking period, signals of the pixels on the same line are stored in the line memories 123. Then, in the horizontal effective period, the signals of the pixels on the same line stored in the line memories 123 are output as an imaging signal.

The horizontal blanking period starts at a time point T₁. Then, at a time point T₂ and when a voltage of a V_{DD} power source 116 and a voltage of a load transistor drive line 119 are high (“H”), a reset pulse is supplied to the n^{th} reset pulse line 132 (n is a positive integer) to reset the FDs 117. At the same time, sensing transistors 114 on the n^{th} line enter a selected state.

At a time point T₃, a readout pulse is supplied to a readout pulse line 131 to read the charges of the PDs 111 to the FDs 117. Signals of the read-out charges are stored in the line memories 123 through the sensing transistors 114.

At a time point T₄ and when the voltage of the V_{DD} power source 116 and the voltage of the load transistor drive line 119 are low (“L”), a reset pulse is supplied to the n^{th} reset pulse line 132 such that the potential of the FDs 117 becomes “L” and the sensing transistors 114 on the n^{th} line enter an unselected state. Then, at a time point T₅, the horizontal blanking period is ended and the horizontal effective period starts. The signals stored in the line memories 123 are sequentially output as an imaging signal by driving the horizontal shift register 142 in the horizontal effective period.

### [Patent Literature 1] Japanese Unexamined Patent Publication 7-154699

### DISCLOSURE OF THE INVENTION

### Problem that the Invention is to Solve

In order to apply the solid state imaging device to cameras and the like, it is necessary to perform electronic shuttering operation for controlling exposure time to store charges that are photoelectrically converted by the PDs 111. As shown in FIG. 7, the exposure time for the PDs 111 on the n+1^{th} line is between the falling edges of the reset pulse and the readout pulse supplied at an optional time point in the effective period for the n^{th} line and a time point T₈ at which the reading on the n+1^{th} line starts.

At a time point T₆, a reset pulse is supplied to the n+1^{th} reset pulse line 132 and a readout pulse is supplied to the n+1^{th} readout pulse line 131. Since the voltage of the V_{DD} power source 116 is “H” and the voltage of the load transistor drive line 119 is “L” at the time point T₆, the potential of the FDs 117 is “H”. When the readout transistors 112 are turned on, the charges of the PDs 111 are read to the FDs 117 and at the same time, the charges are delivered to the V_{DD} power source 116. The signals of the delivered charges are not stored in the line memories 123 because the load transistors 118 are off.

In the conventional solid state imaging device, a drive pulse for the n+1^{th} line is supplied in the horizontal effective period for the n^{th} line to perform the electronic shuttering operation. The drive pulse at the time point T₆ induces external noise in the imaging signal and brings about a problem of significant deterioration in image quality.

An object of the present invention is to provide a solution to the conventional problem, i.e., to provide a solid state imaging device in which image quality is not deteriorated by external noise even if electronic shuttering operation is performed and a driving method therefor.

### Means of Solving the Problem

In order to achieve the object, the present invention is configured such that the output of the solid state imaging device is suspended for the electronic shuttering operation.

To be more specific, the solid state imaging device of the present invention includes an imaging circuit having a plurality of pixels arranged in a matrix and outputting signals of the pixels line by line as an imaging signal containing a discontinuous portion; and a signal processing circuit having a memory which temporarily stores the imaging signal and a memory controller which writes and reads the imaging signal to and from the memory, the signal processing circuit converting the imaging signal containing the discontinuous portion into a continuous image signal.

The solid state imaging device of the present invention includes the imaging circuit outputs signals of the pixels by lines as an imaging signal containing a discontinuous portion and the signal processing circuit which converts the imaging signal containing the discontinuous portion into a continuous image signal. Therefore, the imaging signal is prevented from being influenced by external noise and precise image data is obtained. Thus, image quality deterioration by the external noise is restrained and the solid state imaging device is realized with high image quality.

Regarding the solid state imaging device of the present invention, it is preferable that the memory controller is a circuit which writes the imaging signal containing the discontinuous portion to the memory as a continuous signal and then reads the written signal from the memory. Further, the memory controller may be a circuit which writes the imaging signal containing the discontinuous portion to the memory and reads the written signal from the memory as a continuous signal. With this configuration, the imaging signal containing the discontinuous portion is converted into the continuous image signal with reliability.

Regarding the solid state imaging device of the present invention, it is preferable that the imaging circuit outputs the imaging signal in a horizontal effective period not overlapping with a vertical blanking period and a horizontal blanking period and the operation of outputting the imaging signal is suspended when a drive pulse for driving the pixels is supplied in the horizontal effective period. With this configuration, the generation of external noise in the imaging signal is prevented with reliability.

Regarding the solid state imaging device of the present invention, it is preferable that the imaging circuit outputs the imaging signal in a horizontal effective period not overlapping with a vertical blanking period and a horizontal blanking period and the operation of outputting the imaging signal is suspended at a rising edge and a falling edge of a drive pulse for driving the pixels. With this configuration, the generation of external noise in the imaging signal is prevented and time to output the imaging signal is ensured.

Regarding the solid state imaging device of the present invention, it is preferable that each of the pixels includes a photoelectric converter, a floating diffusion for reading a charge of the photoelectric converter, a readout transistor connected between the photoelectric converter and the floating diffusion, a reset transistor for resetting the state of the floating diffusion and a sensing transistor for sensing a charge stored in the floating diffusion, and the drive pulse includes a readout pulse for driving the readout transistor and a reset pulse for driving the reset transistor.

Regarding the solid state imaging device of the present invention, it is preferable that the imaging circuit includes a plurality of line memories arranged in one-to-one correspondence with columns of the pixels to store charges of the pixels on a selected line among the plurality of pixels and a horizontal shift register for sequentially reading the charges stored in the line memories and outputting the charges as the image signal and the operation of outputting the image signal is suspended by stopping the operation of the horizontal shift register.

Regarding the solid state imaging device of the present invention, it is preferable that the signal processing circuit includes a timing generator which generates an imaging circuit drive signal for driving the imaging circuit and a memory controller drive signal for driving the memory controller and the memory controller drive signal includes a signal for informing the memory controller that the operation of the horizontal shift register is stopped. With this configuration, the imaging signal containing the discontinuous portion is converted into the continuous image signal with reliability.

A camera according to the present invention includes the solid state imaging device of the present invention.

A method for driving a solid state imaging device according to the present invention is directed to a method for driving a solid state imaging device including an imaging circuit having a plurality of pixels arranged in a matrix and outputting signals of the pixels line by line as an imaging signal containing a discontinuous portion and a signal processing circuit for processing the imaging signal. The method includes the steps of: supplying a drive pulse for driving the pixels in a horizontal effective period not overlapping with a vertical blanking period and a horizontal blanking period; suspending the operation of outputting the imaging signal at least at a rising edge and a falling edge of the drive pulse; and removing a portion in which the output of the imaging signal is suspended to generate a continuous image signal.

The method for driving the solid state imaging device of the present invention includes the step of suspending the operation of outputting the imaging signal at least at a rising edge and a falling edge of the drive pulse. As a result, the imaging signal is not influenced by external noise due to high speed electric shutter operation. This makes it possible to improve image quality to a large extent. Further, since the method includes the step of removing a portion in which the output of the imaging signal is suspended to generate a continuous image signal, a precise image signal is obtained.

### EFFECT OF THE INVENTION

According to the solid state imaging device and the driving method of the present invention, image quality deterioration by the external noise does not occur even if the electronic shuttering operation is performed.

### BRIEF DESCRIPTION OF DRAWINGS

FIG. 1 is a block diagram illustrating the configuration of a solid state imaging device according to Embodiment 1 of the present invention.

FIG. 2 is a circuit diagram illustrating the configuration of an imaging circuit of the solid state imaging device according to Embodiment 1 of the present invention.

FIG. 3 is a timing chart of the operation of the solid state imaging device according to Embodiment 1 of the present invention in a horizontal drive period not overlapping with a vertical blanking period.

FIG. 4 is a timing chart of the operation of a solid state imaging device according to Embodiment 2 of the present invention in a horizontal drive period not overlapping with a vertical blanking period.

FIG. 5 is a block diagram illustrating the structure of a camera according to Embodiment 2 of the present invention.

FIG. 6 is a circuit diagram of an example of a conventional solid state imaging device.

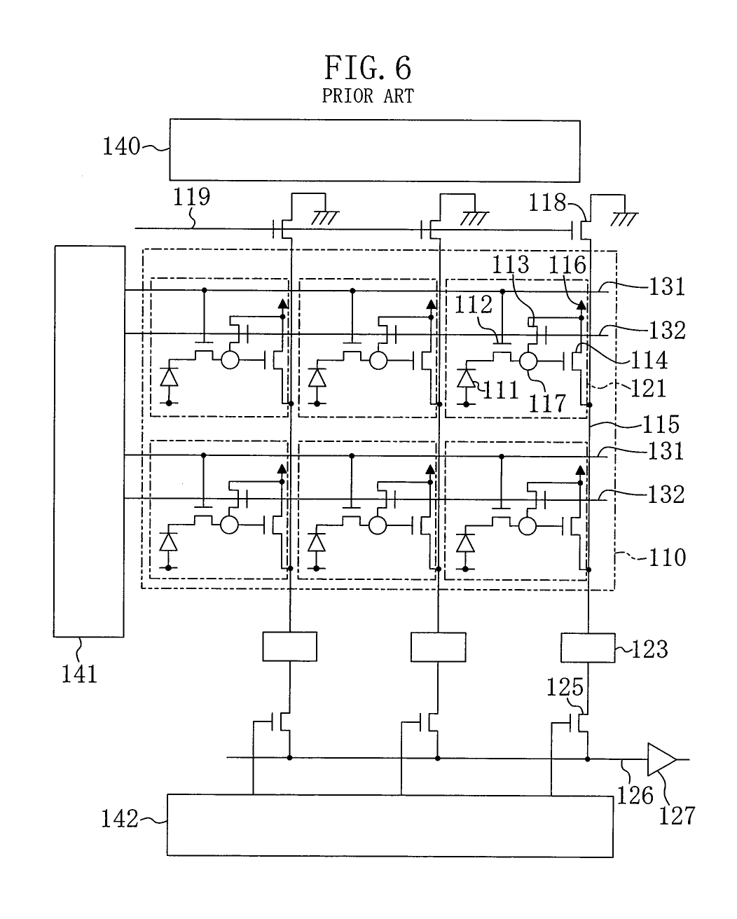

FIG. 7 is a timing chart of the operation of the conventional solid state imaging device in a horizontal drive period not overlapping with a vertical blanking period.

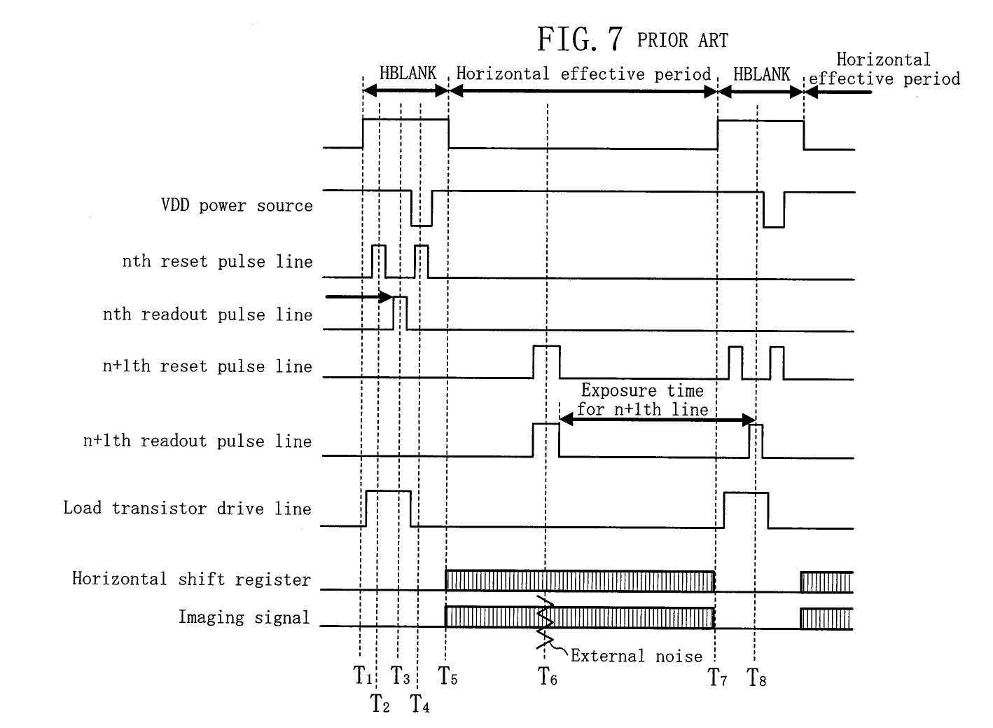

### EXPLANATION OF REFERENCE NUMERALS

11 Photoelectric converter
12 Readout transistor
13 Reset transistor
14 Sensing transistor
15 Vertical signal line
16 V_{DD} power source
17 Floating diffusion
18 Load transistor
19 Load transistor drive line
20. Imaging region
21 Pixel
23 Line memory
26 Horizontal signal line
27 Output amplifier
31 Readout pulse line
32 Reset pulse line
41 Vertical shift register
42 Horizontal shift register
50 Imaging circuit
51 Signal processing circuit
52 Analog front end
53 Memory controller
54 Memory
55 Image signal processor
56 Central processing unit
57 Timing generator
58 Interface
71 Solid state imaging device
72 Optical system
73 Display processing circuit
74 Display

### BEST MODE FOR CARRYING OUT THE INVENTION

### Embodiment 1

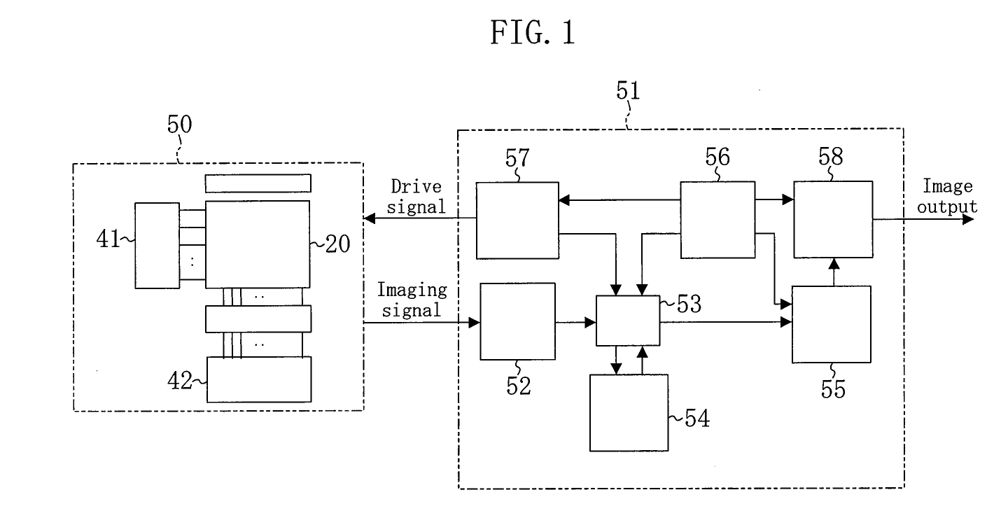

Embodiment 1 of the present invention is described with reference to the drawings. FIG. 1 shows the block configuration of a solid state imaging device according to Embodiment 1 of the present invention. As shown in FIG. 1, the solid state imaging device of the present embodiment includes an imaging circuit 50 which is a MOS solid state imaging element and a signal processing circuit 51 which supplies a drive pulse to the imaging circuit 50 and processes an imaging signal of the imaging circuit 50.

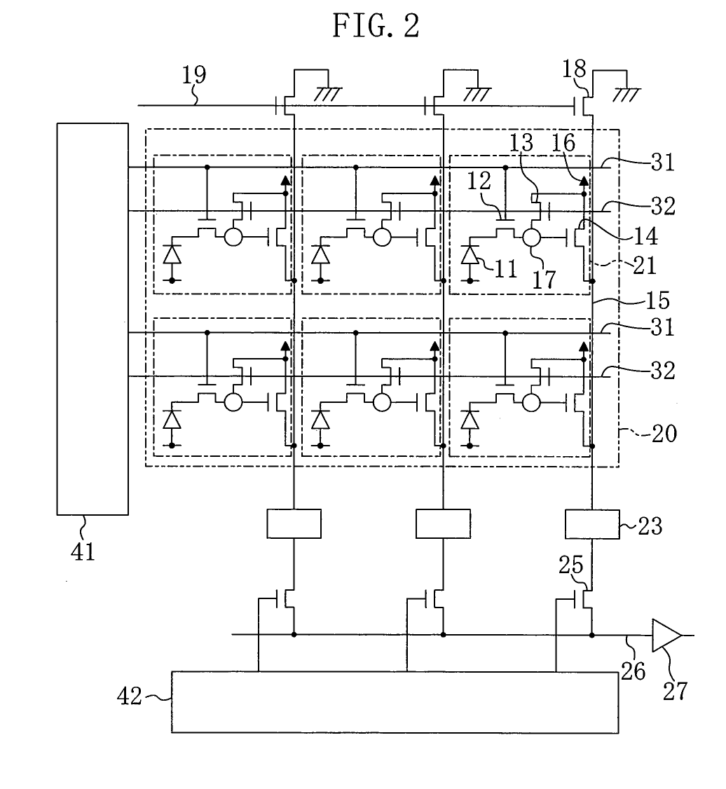

FIG. 2 shows the configuration of the imaging circuit 50. As shown in FIG. 2, the imaging circuit 50 includes an imaging region 20 in which a plurality of amplifying unit pixels 21 are arranged in a matrix. In this drawing, the imaging region 20 includes two lines and three columns of pixels. However, the number of the lines and columns may be defined as required.

Each of the pixels 21 includes a photoelectric converter made of a photodiode (PD) 11 and a floating diffusion (FD) 17 connected to the PD 11 through a readout transistor 12 to store a charge of the PD 11. The FD 17 is connected to a V_{DD} power source 16 through a reset transistor 13 and to a vertical signal line 15 through a sensing transistor 14.

A gate of the readout transistor 12 is connected to a readout pulse line 31 and a gate of the reset transistor 13 is connected to a reset pulse line 32. The readout pulse line 31 and the reset pulse line 32 are provided in each line and a vertical signal line 15 is provided in each column.

To each of the vertical signal lines 15, an input terminal of a line memory 23 for storing signals of the pixels on the same line and a load transistor 18 are connected. The input terminals of the line memories 23 are connected to a horizontal signal line 26 through horizontal control transistors 25, respectively. The horizontal signal line 26 is connected to an output amplifier 27. Each of the load transistors 18 is connected between the corresponding vertical signal line 15 and the ground. The gates of the load transistors are connected to a load transistor drive line 19.

The readout transistor 12 and the reset transistor 13 are driven by a vertical shift register 41. The horizontal control transistors 25 are driven by a horizontal shift register 42. The vertical shift register 41 and the horizontal shift register 42 are driven by a drive pulse supplied from the signal processing circuit 51.

The signal processing circuit 51 includes an analog front end (AFE) 52 which performs sampling and A/D conversion of an analog signal output from the solid state imaging element, a memory controller 53 which writes a digital signal converted by the AFE 52 to a memory 54 and an image signal processor 55 which performs general image signal processes on the image signal read out of the memory 54 such as OB clamping, white balancing and YUV processing. The signal processing circuit 51 further includes an interface 58 which adjusts the format of an image signal output from the image signal processor 55 and outputs the adjusted signal as an image output to the outside of the imaging device, a timing generator (TG) 57 which outputs a signal for driving the imaging circuit 50 and a control signal for the memory controller 53 and a central processing unit (CPU) 56 which controls each of the blocks.

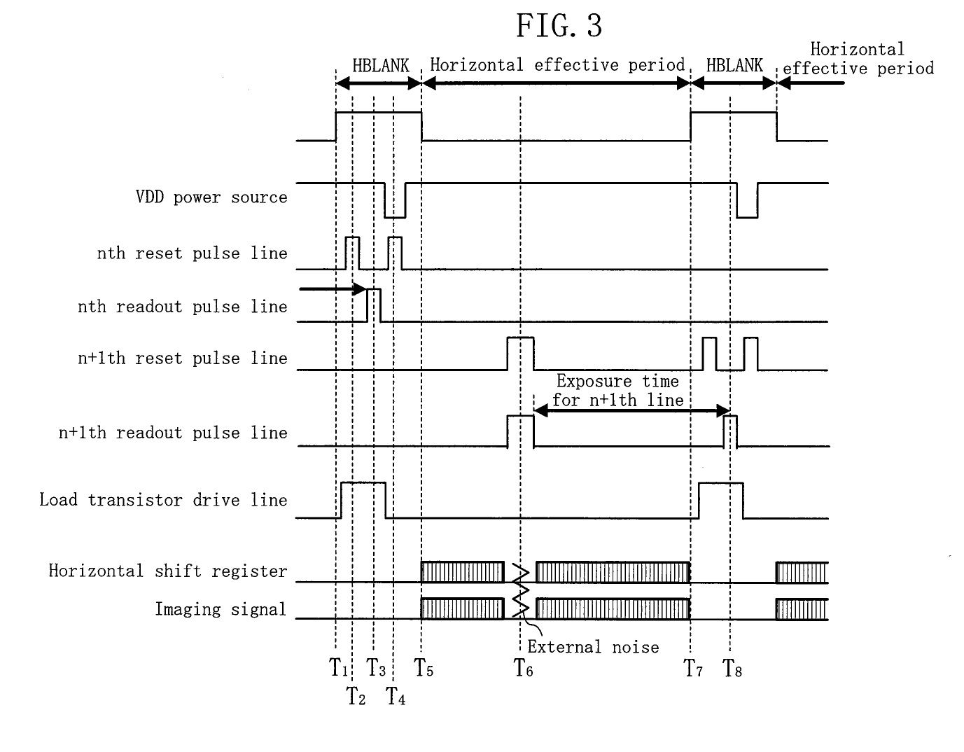

Hereinafter, the operation of the solid state imaging device of the present embodiment is described in detail. FIG. 3 shows the operation timing of the solid state imaging device of the present embodiment in a horizontal drive period not overlapping with a vertical blanking period. Although the drawing illustrates only the timing for driving the pixels on the n^{th} line (n is a positive integer), the operation timing for the pixels on the other lines is performed in the same manner.

The horizontal drive period consists of a horizontal blanking period (HBLANK) and a horizontal effective period. In FIG. 3, the horizontal blanking period starts at a time point T₁ and the horizontal effective period starts at a time point T₅. In the horizontal blanking period, signals are read from the pixels 21 and stored in the line memories 23. In the horizontal effective period, the signals stored in the line memories 23 are sequentially output as an imaging signal. In the horizontal effective period, high-speed electronic shuttering operation for the pixels 21 on the next line is performed.

The horizontal blanking period starts at the time point T₁. Then, at a time point T₂ and when the voltage of the V_{DD} power source 16 and the voltage of the load transistor drive line 19 are high (“H”), a reset pulse is supplied to the n^{th} reset pulse line 32. Accordingly, the reset transistors 13 on the n^{th} line are turned on, the FDs 17 are reset and at the same time, the sensing transistors 14 on the n^{th} line enter a selected state. Then, at a time point T₃, a readout pulse is supplied to the n^{th} readout pulse line 31. As a result, the readout transistors 12 are turned on and charges of the PDs 11 are read to the FDs 17. Signals of the charges read out of the PDs 11 on the n^{th} line are stored in the line memories 23 through the sensing transistors 14.

At a time point T₄ and when the voltage of the V_{DD} power source 16 is “L”, a reset pulse is supplied to the n^{th} reset pulse line 32 and the reset transistors 13 on the n^{th} line are turned on. As a result, the potential of the FDs 17 becomes “L” and the sensing transistors 14 on the n^{th} line enter an unselected state.

At a time point T₅, the horizontal blanking period is ended and the horizontal effective period starts. In the horizontal effective period, the horizontal shift register is driven and the signals of the pixels 21 on the n^{th} line stored in the line memories 23 are sequentially read to the horizontal signal line 26 and output as an imaging signal through the output amplifier 27.

At an optional time point T₆ in the horizontal effective period for the n^{th} line, high-speed electronic shuttering operation for the n+1^{th} line starts. At the time point T₆ and when the voltage of the V_{DD} power source 16 is “H” and the voltage of the load transistor drive line 19 is “L”, a reset pulse is supplied to the n+1^{th} reset pulse line 32 and a readout pulse is supplied to the n+1^{th} readout pulse line 31. Accordingly, the reset transistors 13 on the n+1^{th} line and the readout transistors 12 on the n+1^{th} line are turned on. As a result, the potential of the FDs 17 becomes “H” and the charges of the PDs 11 are delivered to the V_{DD} power source 16. Since the load transistors 18 are off, signals of the delivered charges are not stored in the line memories 23 through the sensing transistors 14 on the n+1^{th} line.

At a time point T₇, the horizontal effective period is ended and the output of the imaging signals is finished. At the same time, the next horizontal blanking period starts. In this horizontal blanking period, a reset pulse is supplied to the n+1^{th} reset pulse line 32 at a time point T₈ and the charges of the PDs 11 on the n+1^{th} line are read. The charges read at this time are those stored in the PDs 11 in an exposure period for the n+1^{th} line between the falling edges of the reset pulse and the readout pulse supplied at the time point T₆ and the time point T₈. Thus, the electronic shuttering operation is performed.

In the present embodiment, at the time point T₆ in the horizontal effective period, the reset pulse and the readout pulse are supplied to the pixels 21 on the n+1^{th} line. Accordingly, external noise due to the reset and readout pulses is generated at the time point T₆. According to the present embodiment, however, the operation of outputting the imaging signal of the pixels 21 on the n^{th} line is suspended while the reset and readout pulses are supplied. Therefore, the imaging signal is not influenced by the external noise. In the present embodiment, the output operation is suspended by stopping the operation of the horizontal shift register 42.

According to the present embodiment, the imaging signal is not influenced by the external noise. However, since the output operation is suspended, the imaging signal is output as a signal containing a discontinuous portion. For conversion of the imaging signal containing the discontinuous portion into a continuous image signal, the signal processing circuit 51 is provided with the memory 54 and the memory controller 53.

The imaging signal containing the discontinuous portion in the horizontal direction output from the imaging circuit 50 is input to the signal processing circuit 51 and goes through sampling and A/D conversion by the AFE 52. The imaging signal containing the discontinuous portion which has gone through the A/D conversion in the AFE 52 is sequentially stored in the memory 54 through the memory controller 53. In this process, information about when the operation of the horizontal shift register 42 of the imaging circuit 50 is stopped is sent to the memory controller 53 from the TG 57. While the operation of the horizontal shift register 42 is stopped, the imaging signal is not stored in the memory 54. Therefore, the discontinuous portion of the imaging signal is not stored in the memory 54. The imaging signal is converted into a continuous image signal and stored in the memory 54.

The continuous image signal read from the memory 54 is input to the image signal processor 55 and goes through general image signal processing. The image signal output from the image signal processor 55 is input to the interface 58, in which the format of the image signal is adjusted. Then, the adjusted image signal is output to the outside of the solid state imaging device as image output.

The solid state imaging device of the present embodiment is able to obtain a continuous image signal which is not influenced by the external noise generated upon the high-speed electronic shuttering operation. Therefore, as compared with the image signal generated by conventional high-speed electronic shuttering operation, the image quality is improved to a large extent.

After the imaging signal containing the discontinuous portion is sequentially stored in the memory 54, the imaging signal containing the discontinuous portion may be converted into the continuous image signal by skipping the discontinuous portion of the imaging signal upon reading the imaging signal from the memory 54.

### Embodiment 2

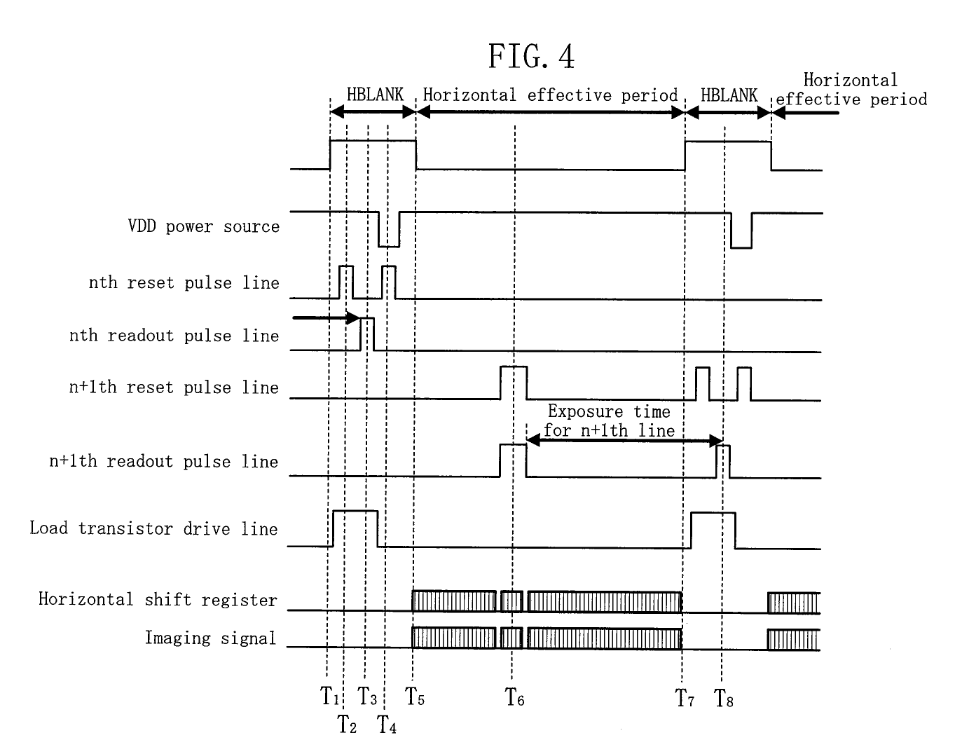

Hereinafter, Embodiment 2 of the present invention is described with reference to the drawings. FIG. 4 illustrates the operation timing of the solid state imaging device of Embodiment 2 in a horizontal drive period not overlapping with a vertical blanking period. The circuit configuration of the solid state imaging device of the present embodiment is the same as that of the solid state imaging device of Embodiment 1. Therefore, the explanation of the configuration is omitted.

In the present embodiment, as shown in FIG. 4, the operation of outputting the imaging signal of the imaging circuit 50 is suspended only at the rising edges and the falling edges of the reset and readout pulses. When the operation of outputting the imaging signal is suspended throughout the period in which the reset and readout pulses are supplied, time to output the signals stored in the line memories 23 may be shortened. From this aspect, in the present embodiment, the operation of the horizontal shift register is stopped to suspend the operation of outputting the imaging signal only at the rising edges and the falling edges of the reset and readout pulses, which are the points of time at which the biggest noise is likely to occur.

In this manner, the problem of lack of time for reading the signals stored in the line memories 23 in the effective period is resolved. Thus, the image is output with precision.

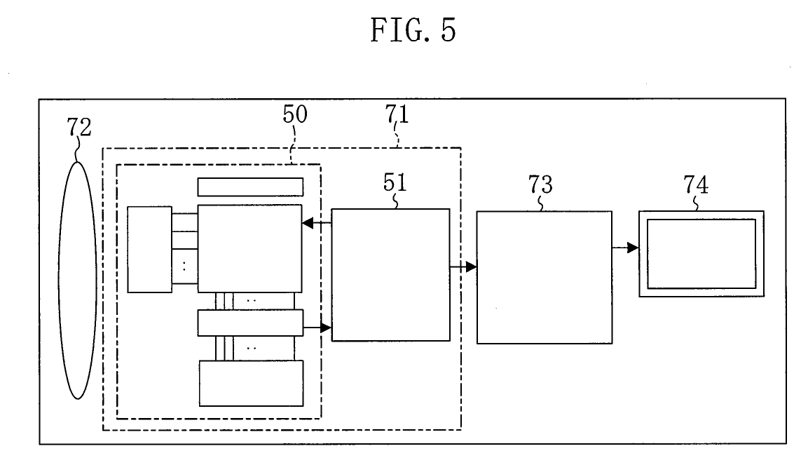

FIG. 5 shows an example of the block configuration of a camera using the solid state imaging device of Embodiment 2. The camera of the present embodiment shown in FIG. 5 includes a solid state imaging device 71 of the present embodiment including the imaging circuit 50 and the signal processing circuit 51, an optical system 72, a display processing circuit 73 for displaying and recording signals output from the solid state imaging device and a display 74. The camera of the present embodiment is able to produce high quality images with little influence of the external noise. The same effect is obtained even if the solid state imaging device of Embodiment 1 is used.

### INDUSTRIAL APPLICABILITY

The solid state imaging device and a driving method therefor according to the present invention make it possible to realize a solid state imaging device in which image quality is not deteriorated by external noise even if electronic shuttering operation is performed and a driving method therefor. Thus, the present invention is useful for a solid state imaging device which performs the electronic shuttering operation and a driving method therefor.

1. (canceled)

2. (canceled)

3. (canceled)

4. (canceled)

5. (canceled)

6. (canceled)

7. (canceled)

8. (canceled)

9. (canceled)

10. (canceled)

11. A solid state imaging device comprising:
an imaging circuit having a plurality of pixels arranged in a matrix and outputting signals of the pixels line by line as an imaging signal containing a discontinuous portion; and
a signal processing circuit having a memory which temporarily stores the imaging signal and a memory controller which writes and reads the imaging signal to and from the memory, the signal processing circuit converting the imaging signal containing the discontinuous portion into a continuous image signal.

12. The solid state imaging device of claim 11, wherein
the memory controller is a circuit which writes the imaging signal containing the discontinuous portion to the memory as a continuous signal and then reads the written signal from the memory.

13. The solid state imaging device of claim 11, wherein
the memory controller is a circuit which writes the imaging signal containing the discontinuous portion to the memory and reads the written signal from the memory as a continuous signal.

14. The solid state imaging device of claim 11, wherein
the imaging circuit outputs the imaging signal in a horizontal effective period not overlapping with a vertical blanking period and a horizontal blanking period, and
the operation of outputting the imaging signal is suspended when a drive pulse for driving the pixels is supplied in the horizontal effective period.

15. The solid state imaging device of claim 14, wherein
each of the pixels includes
a photoelectric converter,
a floating diffusion for reading a charge of the photoelectric converter,
a readout transistor connected between the photoelectric converter and the floating diffusion,
a reset transistor for resetting the state of the floating diffusion and
a sensing transistor for sensing a charge stored in the floating diffusion, and
the drive pulse includes a readout pulse for driving the readout transistor and a reset pulse for driving the reset transistor.

16. The solid state imaging device of claim 14, wherein
the imaging circuit includes
a plurality of line memories arranged in one-to-one correspondence with columns of the pixels to store charges of the pixels on a selected line among the plurality of pixels and
a horizontal shift register for sequentially reading the charges stored in the line memories and outputting the charges as the image signal and
the operation of outputting the image signal is suspended by stopping the operation of the horizontal shift register.

17. The solid state imaging device of claim 16, wherein
the signal processing circuit includes a timing generator which generates an imaging circuit drive signal for driving the imaging circuit and a memory controller drive signal for driving the memory controller and
the memory controller drive signal includes a signal for informing the memory controller that the operation of the horizontal shift register is stopped.

18. The solid state imaging device of claim 11, wherein
the imaging circuit outputs the imaging signal in a horizontal effective period not overlapping with a vertical blanking period and a horizontal blanking period and
the operation of outputting the imaging signal is suspended at a rising edge and a falling edge of a drive pulse for driving the pixels.

19. The solid state imaging device of claim 18, wherein
each of the pixels includes
a photoelectric converter,
a floating diffusion for reading a charge of the photoelectric converter,
a readout transistor connected between the photoelectric converter and the floating diffusion,
a reset transistor for resetting the state of the floating diffusion and
a sensing transistor for sensing a charge stored in the floating diffusion, and
the drive pulse includes a readout pulse for driving the readout transistor and a reset pulse for driving the reset transistor.

20. The solid state imaging device of claim 18, wherein
the imaging circuit includes
a plurality of line memories arranged in one-to-one correspondence with columns of the pixels to store charges of the pixels on a selected line among the plurality of pixels and
a horizontal shift register for sequentially reading the charges stored in the line memories and outputting the charges as the image signal and
the operation of outputting the image signal is suspended by stopping the operation of the horizontal shift register.

21. The solid state imaging device of claim 20, wherein
the signal processing circuit includes a timing generator which generates an imaging circuit drive signal for driving the imaging circuit and a memory controller drive signal for driving the memory controller and
the memory controller drive signal includes a signal for informing the memory controller that the operation of the horizontal shift register is stopped.

22. A camera including the solid state imaging device of claim 11.

23. A method for driving a solid state imaging device including an imaging circuit having a plurality of pixels arranged in a matrix and outputting signals of the pixels line by line as an imaging signal containing a discontinuous portion and a signal processing circuit for processing the imaging signal, the method comprising the steps of:
supplying a drive pulse for driving the pixels in a horizontal effective period not overlapping with a vertical blanking period and a horizontal blanking period;
suspending the operation of outputting the imaging signal at least at a rising edge and a falling edge of the drive pulse; and
removing a portion in which the output of the imaging signal is suspended to generate a continuous image signal.
